(19) United States
(12) Patent Application Publication
(10) Pub. No.: US 2004/0007917 A1
(43) Pub. Date: Jan. 15, 2004

(54) Cascaded network power control system

(75) Inventors: Sen Jia Wu, Taipei (TW); Wen-Fu Tsai, Taipei (TW); Jiann-Yi Fann, Taipei (TW); Fu-Hsiu Chiang, Taipei (TW)

Correspondence Address: BROWDY AND NEIMARK, P.L.L.C., 624 NINTH STREET, NW, SUITE 300, WASHINGTON, DC, 20001-5303, US

(73) Assignee: ALLIS ELECTRIC CO., LTD., Taipei (TW)

(21) Appl. No.: 10/194,064

(22) Filed: Jul. 15, 2002

(51) Int. Cl. H02J 3/14; H02J 3/00; H02J 1/00

(52) U.S. Cl. 307/39

(57) ABSTRACT

The present invention provides a cascaded network power control system comprising at least a controlled power site and a control center. The controlled power site has a front end processor (FEP). The FEP at least has two network ports (an uplink network port and a downlink network port). The control center uses an optical fiber to connect the network ports of the FEP, and uses the network ports of the FEP to establish contact with another controlled power site. The network ports are connected with network ports of a preceding controlled power site and the next controlled power site for transmission of a normal/abnormal signal of an intelligent electricity device (IED) of the preceding controlled power site. The normal/abnormal signal is transmitted to the IED of the local controlled power site via an RS232 or RS485 port.

### FIELD OF THE INVENTION

The present invention relates to a cascaded network power control system and, more particularly, to a cascaded network power control system, which additionally receives and transmits a normal/abnormal signal on a primary optical fiber in a time division multiplexing way. Thereby, each controlled power site of the cascaded network power control system can inform a control center of its real-time situation about whether it is normal or it is abnormal, and can determine whether it should be separated from the whole power system according to the occurred abnormal situation.

### BACKGROUND OF THE INVENTION

A transformer station is a power transforming site for raising or lowering voltage and distributing electricity. During the transmission process of electricity from a power plant to a user's home, the transformer station plays a role like a splitting road of a highway. Before entering a highway, a car needs to accelerate on the splitting road. Similarly, the voltage of electricity from a power plant needs to be raised first by the transformer station. When a car wants to leave the highway and enter an urban area, it must decelerate at the splitting road. Similarly, high-voltage electricity must be stepped down by the transformer station so as to be distributed everywhere and then gradually lowered to voltages usable for users.

A general network control system adopts star connection. In other words, a control center can be respectively connected to at least a controlled power site. It is necessary to perform some real-time data transmission between each controlled power site and the control center. Beside these real-time data, there is real-time transmission of normal/abnormal signals between the controlled power sites so that each controlled power site can exactly grasp the statues of adjacent controlled power sites. In a conventional network control system, these normal/abnormal signals are first converted into optical signals by an electronic-to-optical (E/O) converter connected with an RS232 port for transmitting these signals. Transmission and reception between two points are then performed on an exclusive optical fiber of a primary optical fiber cable. However, practical long-distance connection between the controlled power. sites of the network control system cannot be accomplished due to limit of valid communication length of optical fiber.

FIG. 1 shows a architecture block diagram of a conventional cascaded network power control system 10, which comprises at least a controlled power site (preferred to be a transformer stations) 20 and 30 and a control center 32. A primary optical fiber 34 or 34′ is connected between the controlled power site 20 or 30 and the control center 32 for transmission of real-time data. Besides, there is a power cable 35 (e.g., 22.8 kV) connecting the controlled power sites 20 and 30. This voltage of 22.8 kV will be stepped down at the controlled power sites and then transmitted to the user end for use.

The controlled power site 20 (or 30) comprises at least a circuit breaker 36, 136, 236, and 336, at least a load 37, 137, 237, and 337, at least a repeater 38 and 138, and a front end processor 39. The circuit breaker 36 (or 136, 236, 336) can separate the whole controlled power site 20 from a power cable 35 to protect the controlled power site 20 and even the whole network control system 10 when the controlled power site 20 has abnormal situations. Abnormal situations include over current, short circuit, electric shock, over voltage, and over temperature. In addition to reacting to abnormal situations, there is exchange of real-time data between the control center 32 and the controlled power sites 20 and 30 via the primary optical fiber 34. These real-time data must be converted into electric signals first by an O/E converter (not shown) in the front end processor 39 and then received by the controlled power site 20. Similarly, real-time data to be outputted by the controlled power site 20 must be converted into optical signals first by the O/E converter and then be transmitted on the primary optical fiber 34.

The network power control system 10 further comprises an E/O converter 43, an O/E converter 44, and a secondary optical fiber 134 between the E/O converter 43 and the O/E converter 44. An abnormal signal reacting to abnormal situations is transferred from an RS232 port of the repeater 138 via the E/O converter 43, the secondary optical fiber 134, and the O/E converter 44 to the next controller power site 30. Similarly, a normal signal is transferred and received between the controller power sites 20 and 30 via the secondary optical fiber 134 after E/O and O/E conversions. When the controlled power site 20 can transfer a normal signal to the controlled power site 30, it means that the controlled power site 20 tells the controlled power site 30 there is no abnormal situation.

The bandwidths (e.g., 100 Mbit/s) of the primary optical fiber 34 and the secondary optical fiber 134 are much larger than the transmission rate (e.g., 9600 bit/s) of the RS232 port. If these normal/abnormal signals can be transferred during intervals of time that the real-time data is not transmitted on the primary optical fiber 34, the E/O converter 43, the O/E converter 44, and the secondary optical fiber 134 can be saved. Moreover, exchange of real-time data between the controlled power sites 20 and 30 will not be affected. Much cost can thus be saved for the whole network control system.

### SUMMARY OF THE INVENTION

The primary object of the present invention is to provide a cascaded network power control system, which accomplishes data exchange between each controlled power site and a control center in a time division multiplexing way. The network system of the present invention provides a software and firmware program in a front end processor of each controlled power site so that normal/abnormal signals can be transmitted on the same primary optical fiber as real-time data. Exchange of real-time data between each controlled power site and the control center will not be affected, and the installation cost of an exclusive optical fiber and an optical-to-electronic (O/E) converter can be saved.

To achieve the above object, the cascaded network power control system of the present invention comprises at least a controlled power site and a control center. The controlled power site comprises a front end processor (FEP), at least a circuit breaker, at least a load, and two intelligent electricity devices (IED). The FEP at least comprises an uplink network port and a downlink network port. The control center uses an optical fiber to connect the uplink network port of the nearest FEP, and uses the downlink network port of this FEP to establish contact with next controlled power site. The uplink network port is connected to the downlink network port of the FEP of the preceding controlled power site for transmission of a normal/abnormal signal of an intelligent electricity device (IED) of the preceding controlled power site. A normal/abnormal signal of an IED of the controlled power site is transferred to the uplink network port of the FEP of the next controlled power site. Normal/abnormal signals are used to inform the IED of the controlled power site whether there is an abnormal situation so that the controlled power site having an abnormal situation can be separated from the whole cascaded network power control system.

The various objects and advantages of the present invention will be more readily understood from the following detailed description when read in conjunction with the appended drawings, in which:

### BRIEF DESCRIPTION OF THE DRAWINGS

FIG. 1 is an architecture block diagram of a conventional network power control system;

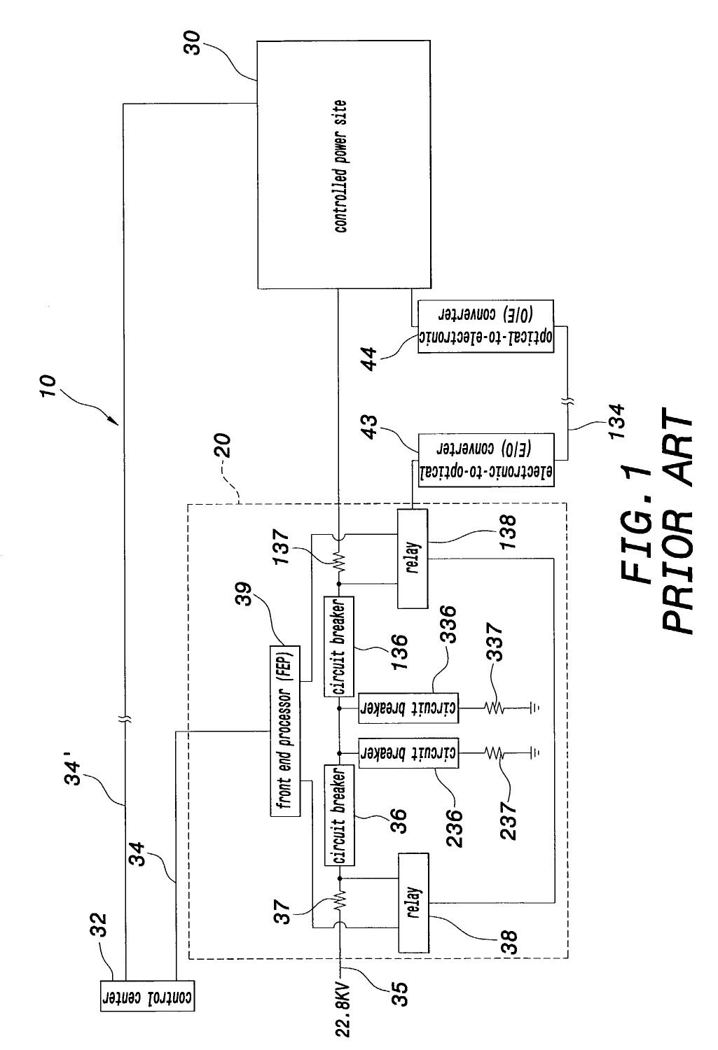

FIG. 2 is a architecture block diagram of a cascaded network power control system of the present invention; and

FIG. 3 is an internal functional block diagram of a front end processor of the cascaded network power control system of the present invention.

### DETAILED DESCRIPTION OF THE PREFERRED EMBODIMENTS

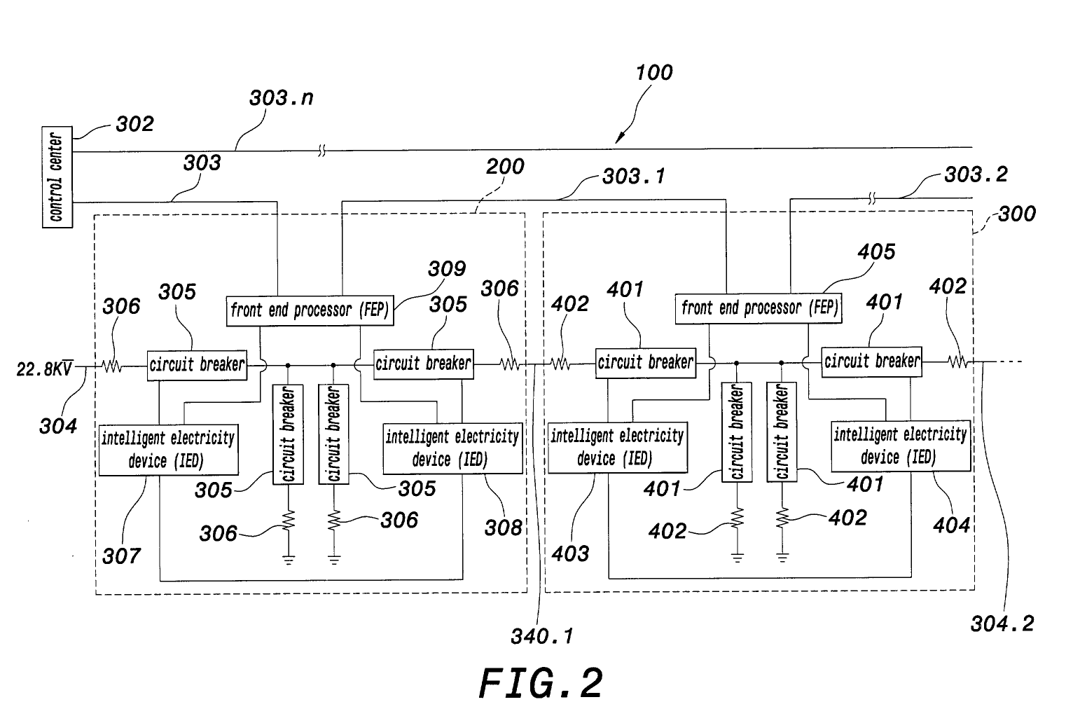

FIG. 2 shows a block diagram of a time division multiplexing cascaded network power control system 100 of the present invention, which comprises at least a controlled power site 200 and 300 series connected together. The present invention also comprises a control center 302 connected to the controlled power sites 200 and 300 via an optical fiber 303 and a power cable (a power cable of 22.8 kV in this embodiment) similarly connected to the controlled power sites 200 and 300.

The controlled power sites 200 and 300 are identical, each comprising at least a circuit breaker 305 (401), a load 306 (402), an intelligent electricity device (IED) 307, 308 (403, 404), and a front end processor (FEP) 309 (405). The FEP 309 (405) comprises an uplink network port and a downlink network port (not shown).

The uplink network port of the FEP 405 is connected to the downlink network port of the FEP 309 of a preceding controlled power site (preferred to be the controlled power site 200) for reception/transmission of a normal/abnormal signal of the FEP 309 of the preceding controlled power site 200. The normal/abnormal signal is used to inform the control center 302 whether there is an abnormal situation. Therefore, when there is an abnormal situation, a power cable of the controlled power site having the abnormal situation can be separated from the power cable 304 so that the controlled power site 200 can be separated from the cascaded network power control system 100.

Because the controlled power sites 200 and 300 are connected via a primary optical fiber of series 303 like 303.1, 303.2˜303.n, the outward interface of the FEP 309 (405) is the optical fiber 303. O/E converters are built in the FEP 309 (405). The optical fiber interface is also called a network port.

The controlled power sites 200 and 300 and the control center 302 utilize the optical fiber 303 to transmit and receive real-time control data at any time. In addition to these real-time data, the normal/abnormal signal for informing the control center 302 of whether there is any controlled power site having an abnormal situation is also transmitted and received via the optical fiber 303 of larger bandwidth (transmission rate). For example, when the controlled power site 200 has an abnormal situation, in addition that the circuit breaker 305 is separated from the power cable 304 by the controlled power site 200 for protecting the controlled power site 200, there is an abnormal signal transferred to the uplink network port of the FEP 405 of the next controlled power site 300 via the downlink network port of the FEP 309. Simultaneously, this abnormal signal will be continually sent to the control center 302 via the optical fiber 303 along a shortest optical fiber path. Similarly, if the controlled power site 300 has an abnormal situation, the system will follow the principle of sending back along a shortest optical path. Therefore, this abnormal signal will be transferred to the downlink network port of the FEP 309 of the preceding controlled power site 200 via the uplink network port of the FEP 405, and then continually sent from the uplink network port of the FEP 309 to the control center 302 via the optical fiber 303.

In the conventional system, lower-speed serial transmission ports like an RS232 port (9.6 Kb) and an exclusive 9.6 Kb O/E converter are required for reception and transmission of the normal/abnormal signals. In the present invention, a software or firmware is written in the FEPs 309 and 405 to transmit and receive these normal/abnormal signals via the optical fiber 303. This kind of design will not affect the original transmission rate of real-time control data transmitted via the optical fiber 303, and can effectively utilize the large bandwidth of optical fiber to achieve quick transmission and reception of normal/abnormal signals in a time division multiplexing way. Simultaneously, when there is an abnormal situation in the transmission path (i.e., some controlled power sites), because the optical fiber 303 is divided into several sections (like 303.1 to 303.n), other controlled power sites having no abnormal situation can still establish contact with the control center via the optical fiber sections of other unbroken controlled power sites.

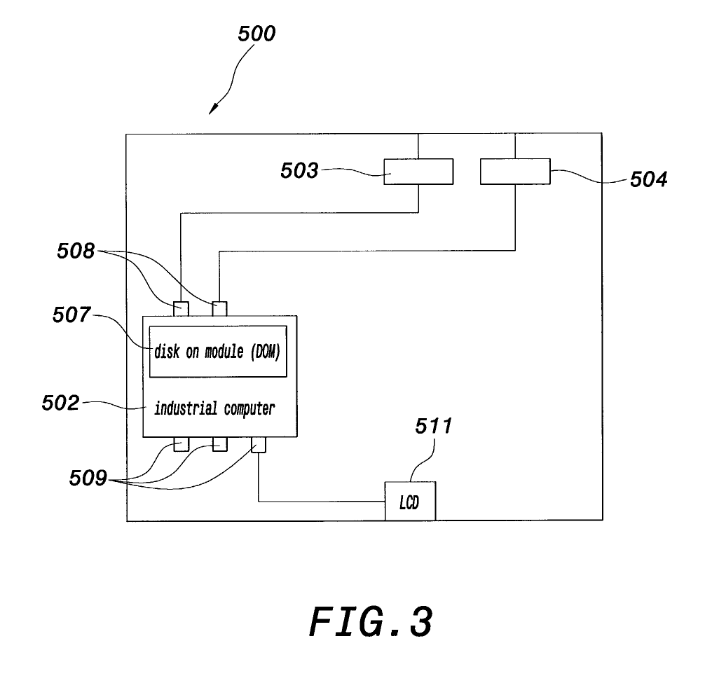

As shown in FIG. 3, the FEP 500 comprises an industrial computer 502 and a set of EO converters 503 and 504. The EO converters 503 and 504 are used to convert inputted optical signals into electric signals or electric signals inside the FEP 500 into optical signals, and then transmit them to an Ethernet network port 508 of the industrial computer 502 or the optical fiber, respectively.

The industrial computer 502 also comprises a disk on module (DOM) 507 for storing software programs, at least two Ethernet network ports 508 connected to the EO converters 503 and 504, and at least an RS232 port 509 connected to the IED. When the local controlled power site has an abnormal situation, the abnormal signal reflected by the IEDs will be transmitted to the optical fiber via the RS232 port 509 and the Ethernet network port 508 to be relayed by the next controlled power site or directly transferred to the control center (this situation occurs when the local controlled power site is the nearest to the control center). In addition to abnormal signals, the RS232 port 509 can also be used to transmit normal signals. Transmission of signals is performed at both normal and abnormal situation. Because the transmission rate of the RS232 port 509 is inevitably smaller than the transmission rate of the present optical fiber technique, in addition to being used to transmit real-time control data, the optical fiber can also be used to additionally transmit normal/abnormal signals through design of the software/firmware program stored in the DOM 507. In addition to not affecting the transmission and reception of the original real-time control data, the actions of transmission and reception of normal/abnormal signal can be sped up to enhance the operational efficiency of the whole cascaded network power control system.

The Ethernet network port 508 can also be connected to a computer. System maintenance men can perform modification and debugging of the software/firmware program through operation of computer. The FEP 500 can also comprise a display screen 511 electrically connected to the RS232 port 509 to display the operation state of the FEP 500.

As compared to the prior art, the time division multiplexing cascaded network power control system of the present invention can extend the practical distribution distance of system to wider range within a receptible range of time delay, and can transmit/receive normal/abnormal signals through residual bandwidth of an optical fiber originally used to transmit real-time control data only. Through design of a software/firmware program, these normal/abnormal signals can be relayed for transmission by every possible controlled power site to the control center along a shortest optical fiber path so that the control center can be informed of whether there is an abnormal situation. Therefore, another optical fiber and an OE converter between controlled power sites in the prior art can be omitted, hence greatly reducing the installation cost of the whole network system.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A cascaded network power control system comprising:
(1) at least a controlled power site comprising:
(a) a front end processor at least comprising an uplink network port and a downlink network link;
(b) at least a circuit breaker;
(c) at least a load; and
(d) two intelligent electricity devices electrically connected to said front end processor and said circuit breaker, respectively; and
(2) a control center connected to said uplink network port of said front end processor via an optical fiber, said control center utilizing said downlink network port of said front end processor to establish contact with another controlled power site;
wherein said uplink network port being electrically connected to said downlink network port of said front end processor of a preceding controlled power site and used to receive a normal/abnormal signal of said front end processor of the preceding controlled power site and transmit said normal/abnormal signal to said uplink network port of said front end processor of a next controlled power site via said downlink network port, said normal/abnormal signal being used to inform said control center of whether there is an abnormal situation so that said controlled power site having an abnormal situation can be separated from said cascaded network power control system.

2. The cascaded network power control system as claimed in claim 1, wherein said front end processor further comprises a pair of electronic-to-optical converters.

3. The cascaded network power control system as claimed in claim 2, wherein said front end processor further comprises an industrial computer.

4. The cascaded network power control system as claimed in claim 3, wherein said electronic-to-optical converters are used to convert an optical signal on said optical fiber into a corresponding electronic signal or convert said electronic signal of said intelligent electricity device into said optical signal.

5. The cascaded network power control system as claimed in claim 3, wherein said industrial computer further comprises at least an RS232 port electrically connected to said intelligent electricity device.

6. The cascaded network power control system as claimed in claim 5, wherein a signal transmission rate of said RS232 port is smaller than a signal transmission rate of said optical fiber.

7. The cascaded network power control system as claimed in claim 1, wherein said normal/abnormal signal sent back to said control center goes along a shortest path of said optical fiber.

8. The cascaded network power control system as claimed in claim 1, wherein there is also a real-time control data similarly transmitted via said optical fiber.

9. A time division multiplexing cascaded network power control system comprising:
(1) at least a controlled power site comprising:
(a) a front end processor at least comprising an uplink network port and a downlink network link;
(b) at least a circuit breaker;
(c) at least a load; and
(d) two intelligent electricity devices electrically connected to said front end processor and said circuit breaker, respectively; and
(2) a control center connected to said uplink network port of said front end processor via an optical fiber, said control center utilizing said downlink network port of said front end processor to establish contact with another controlled power site;
wherein said uplink network port being used to receive a normal/abnormal signal and transmit to said front end processor of another controlled power site, said normal/abnormal signal being used to inform said control center of whether there is an abnormal situation so that said controlled power site having an abnormal situation can be separated from said time division multiplexing cascaded network power control system, said normal/abnormal signal being transmitted along a shortest path of said optical fiber in a time division multiplexing way.

10. The time division multiplexing cascaded network power control system as claimed in claim 9, wherein said front end processor further comprises a pair of electronic-to-optical converters.

11. The time division multiplexing cascaded network power control system as claimed in claim 10, wherein said front end processor further comprises an industrial computer.

12. The time division multiplexing cascaded network power control system as claimed in claim 11, wherein said electronic-to-optical converters are used to convert an optical signal on said optical fiber into a corresponding electronic signal or convert said electronic signal of said intelligent electricity device into said optical signal.

13. The time division multiplexing cascaded network power control system as claimed in claim 11, wherein said industrial computer further comprises at least an RS232 port electrically connected to said intelligent electricity device.

14. The time division multiplexing cascaded network power control system as claimed in claim 13, wherein a signal transmission rate of said RS232 port is smaller than a signal transmission rate of said optical fiber.
